(19) United States
(12) Patent Application Publication
(10) Pub. No.: US 2025/0371438 A1
(43) Pub. Date: Dec. 4, 2025

(54) EXPLANATION OF ENSEMBLE MODEL OUTPUT

(71) Applicant: Intuit Inc., Mountain View, CA (US)

(72) Inventors: Nazanin Zaker HABIBABADI, Mountain View, CA (US); Nathan OSBORNE, San Diego, CA (US); Wei WANG, San Jose, CA (US); Xue HAN, Mountain View, CA (US); Atanu ROY, Mountain View, CA (US); Rachita RAMESH, Mountain View, CA (US)

(73) Assignee: Intuit Inc., Mountain View, CA (US)

(21) Appl. No.: 18/907,391

(22) Filed: Oct. 4, 2024

Related U.S. Application Data
(60) Provisional application No. 63/654,914, filed on May 31, 2024.

(51) Int. Cl. G06N 20/20

(52) U.S. Cl. CPC G06N 20/20

(57) ABSTRACT

A method including applying a stacked ensemble model having a number of component models to a user profile. Values for the features are extracted from the user profile. A first contribution matrix, generated for the first model, contains first feature importance scores for the first subset of the features used in the first model. A second contribution matrix, generated for the second model, contains second feature importance scores for the second subset of the features used in the second model. An overall feature importance matrix is generated by combining the first contribution matrix and the second contribution matrix. A set of top features including a third subset of the features is selected from the overall feature importance matrix. An explanation for the final output is generated according to the set of top features. The explanation is presented.

### CROSS REFERENCE TO RELATED APPLICATIONS

This application claims the benefit of U.S. Provisional Application No. 63/654,914, filed May 31, 2024, which is hereby incorporated by reference herein.

### BACKGROUND

Artificial intelligence (AI) is used to evaluate situations and make one or more predictions upon which a decision may be made. When using AI for such tasks, justifying the prediction may be helpful to evaluate the model and make the decision. However, many models operate as a “black box,” wherein the reasoning behind the prediction is unknown.

Treating these models as a “black box” diminishes confidence in the prediction of the model. The development of explainable artificial intelligence (XAI) methods addresses the issue of diminished confidence. XAI allows human users to comprehend the results from machine learning algorithms.

However, the use of ensemble models, which may feature stacked layers of models, can complicate XAI. Ensemble models may use an explainer model, such as a Kernel explainer, to identify top contributing factors and explanations for the ensemble model's decisions making process. Unfortunately, current explainer models are slow, relative to certain other models, and are unable to be used in real-time model call situations. Furthermore, policy changes and data shifts may force users to retrain the explainer model periodically.

### SUMMARY

One or more embodiments provide for a method. The method includes applying a stacked ensemble model to a user profile, the stacked ensemble model including a number of component models. The stacked ensemble model operates on a number of features to generate a final output. Values for the features are extracted from the user profile. The stacked ensemble model includes a first model at a first layer and a second model subsequent to the first model. The first model operates on a first subset of the features to generate an intermediary feature. The second model receives, as input, the intermediary feature and also operates on a second subset of the features to generate the final output. The method also includes generating, for the first model, a first contribution matrix containing first feature importance scores for the first subset of the features used in the first model. The method also includes generating, for the second model, a second contribution matrix containing second feature importance scores for the second subset of the features used in the second model. The method also includes generating an overall feature importance matrix by combining the first contribution matrix and the second contribution matrix. The method also includes selecting, from the overall feature importance matrix, a set of top features including a third subset of the features. The method also includes generating, according to the set of top features, an explanation for the final output. The method also includes presenting the explanation.

One or more embodiments also provide for a system. The system includes a server having a processor. The system also includes a stacked ensemble model executable by the processor and having a number of component models, the number of component models including a first model at a first layer and a second model subsequent to the first model. The system also includes a data repository in communication with the processor. The data repository stores a user profile including a number of features. The data repository also stores a first subset of the features used in the first model. The data repository also stores a second subset of the features used in the second model. The data repository also stores a first contribution matrix containing first feature importance scores for the first subset. The data repository also stores a second contribution matrix containing second feature importance scores for the second subset of the features used in the second model. The data repository also stores an overall feature importance matrix. The data repository also stores a set of top features including a third subset of the features. The data repository also stores an explanation for a final output of the stacked ensemble model. The system also includes a matrix combiner. The matrix combiner is executable by the processor to apply the matrix combiner to the first contribution matrix and to the second contribution matrix to output the overall feature importance matrix. The system also includes a server controller executable by the processor to perform a computer-implemented method. The computer-implemented method includes applying the stacked ensemble model to the user profile. The computer-implemented method also includes generating, for the first model, the first contribution matrix. The computer-implemented method also includes generating, for the second model, the second contribution matrix. The computer-implemented method also includes generating the overall feature importance matrix by combining the first contribution matrix and the second contribution matrix. The computer-implemented method also includes selecting, from the overall feature importance matrix, the set of top features. The computer-implemented method also includes generating, according to the set of top features, the explanation. The computer-implemented method also includes presenting the explanation.

One or more embodiments provide for another method. The method includes applying a stacked ensemble model to a user profile, the stacked ensemble model including a number of component models. The stacked ensemble model operates on a number of profile features to generate a final output. Values for the profile features are extracted from the user profile. The stacked ensemble model includes a first model at a first layer and a second model subsequent to the first model. The first model operates on a first subset of the profile features to generate a first intermediary feature. The second model generates the final output, based at least in part on the first intermediary feature. The method also includes generating, for the first model, a first contribution matrix containing first feature importance scores for the first subset of the profile features used as input to the first model. A first column of the first contribution matrix represents the first model. Each input to the first model corresponds to a row of the first contribution matrix. The method also includes generating, for the second model, a second contribution matrix aggregating second feature importance scores for input features used as input to the second model. The method also includes generating an overall feature importance matrix by combining the first contribution matrix and the second contribution matrix, the overall feature importance matrix is a vector matrix where each row indicates a significance of a corresponding input feature. The method also includes selecting, from the overall feature importance matrix, a set of top features including a second subset of the profile features. The method also includes generating, according to the set of top features, an explanation for the final output, the explanation including a weighted value representing an importance of the top feature in determining the final output. The method also includes presenting the explanation.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method for providing an explanation of an ensemble model output, in accordance with one or more embodiments.

FIG. 3, FIG. 4, and FIG. 5 shows an example of providing an explanation of an ensemble model output, in accordance with one or more embodiments.

FIG. 6A and FIG. 6B show an example of a computing system and network environment, in accordance with one or more embodiments.

Like elements in the various figures are denoted by like reference numerals for consistency.

### DETAILED DESCRIPTION

One or more embodiments are directed to improvements in the explanation of outputs of ensemble models. In particular, one or more embodiments provide for an automated explanation of an ensemble model output at greater speeds which may approach or equal in real-time. “Real-time” means a period of time that is less than a selected threshold amount of time. The definition of “real-time” may vary for different aspects of a system. For example, a “real-time” call in a system may less than a first threshold amount of time that is less than some other process in the system. However, a “real-time” execution of an XAI model may be a second threshold of time that may be predetermined or defined by an average execution time of an ensemble model in the system. In any case, a computer scientist may quantitatively determine the specific meaning of “real-time” in a given context or embodiment.

Ensemble models, which have stacked models over multiple layers, can be used for AI-based decision making. The process of making the decision by the model may be evaluated, in real-time, in order to provide a calculation of the impact each input feature has on the model output. In other words, one or more embodiments improve the speed at which a determination is made regarding how much each input feature of the model contributes to the output of the model. The top features, such as the 10 highest ranked features, can then be provided as an explanation of the output of the model.

Further refinement of the explanation is also possible. For example, the 10 highest ranked features may be cross referenced with a library of natural language text, such as a reason code. In turn, one or more natural language messages (e.g., reason codes) in the natural language library are selected according to the ten highest ranked features. The one or more natural language messages then may be transmitted to a user.

AI model predictions may be used in many fields. For example, an AI model prediction may be used in Security, Risk and Fraud (SRF) applications. While the AI model prediction may be helpful for making automated security decisions, users may prefer the decision to be made transparent (for example, for auditing purposes) in order to justify any diverse action on the customers or customer experiences. Much of the conventional work on SRF does not use meta or stacked models, and lacks explainability, especially if used in real-time.

Since the users are mostly policy teams (non-Al business units) across different SRF products, and many stakeholders do not have a solid foundation in the models, providing explainability is desirable. XAI methods allow human users to better comprehend the results from complex computer algorithms by making them easier to interpret.

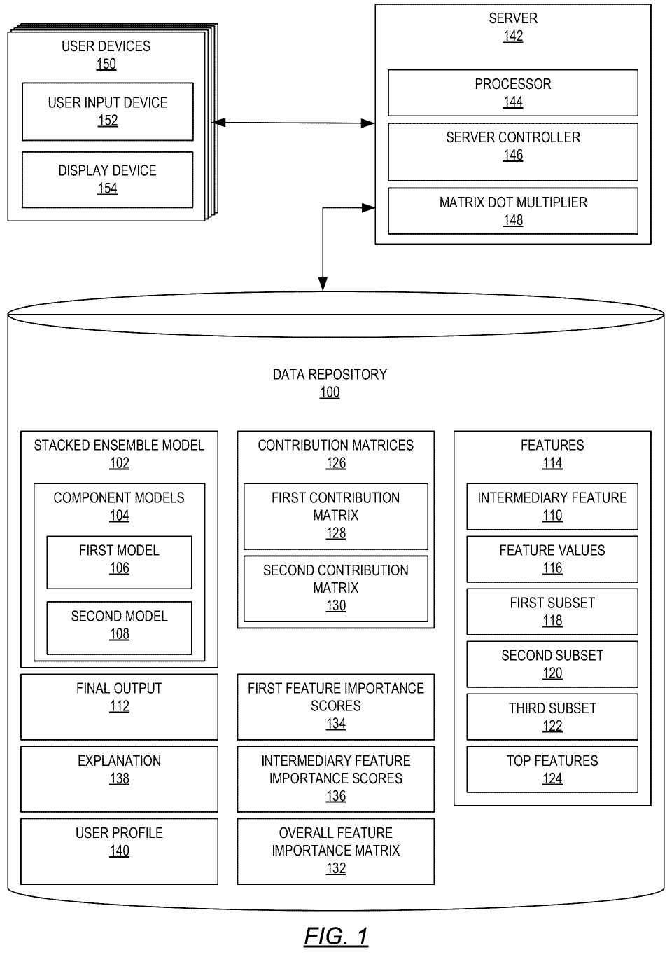

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores a user profile (140). The user profile (140) includes features (114) having associated feature values (116). Features (114) include various details or variables that may be used by the ensemble model as input. For example, when making a financial risk assessment or fraud detection, the features (114) may include features such as, but not limited to, past payment history, yearly income, total debts, etc.

The data repository (100) also stores a stacked ensemble model (102). The stacked ensemble model (102) is a program or algorithm, such as a machine learning model, which has multiple component models (104) on various layers. The component models (104) are individual machine learning models within the stacked ensemble model (102). The multiple component models (104) are distributed on various layers, such as a first model (106) on a first layer and a second model (108) on a subsequent layer.

The stacked ensemble model (102 takes features (114) as input and generates a final output (112). The component models (104) operate on different inputs. For example, a first model from the first layer component models (104) operates on a first subset of features (114) and a second model from the first layer component models (104) operates on a second, different subset of features (114). The results of various of the component models (104) are combined to generate the final output (112). For example, the results of the component models (104) on the first layer may be received as input by the second model (108). The second model (108) then generates the final output (112).

The stacked ensemble model (102) takes as input one or more features (114). The stacked ensemble model (102), when executed, generates a final output (112). The first model (106) receives, as input, a first subset (118) of the features (114) and produces an intermediary feature (110). The intermediary feature (110) is provided as input to a subsequent model of the stacked ensemble model (102) at a subsequent layer.

The second model (108) produces the final output (112) of the stacked ensemble model (102). The second model (108) operates on a second subset (120) of the features (114), such as an intermediary feature (110) from the first model (106) of the component models (104). The final output (112) may be one or more numbers (e.g., an output vector) or text (in the case of language models) that may form the basis to execute a subsequent decision or to take some other action.

The data repository (100) also stores a third subset of features (122) which represent a set of top features (124). The set of top features (124) are the features (114) having a greater measurable impact on the final output (112), relative to other features (114).

The data repository (100) also stores one or more contribution matrices (126). Each contribution matrix is a data structure that stores numbers that reflect the relative importances of the features (114) to the output of one component model, such as the component model (104). For example, a first contribution matrix (128) in the contribution matrices (126) represents the importance of the features (114) used as input to the first model (106) to the output of the first model (106), and a second contribution matrix (130) represents the importance of the features (114) used as input to the second model (108) to the output of the second model (108).

The data repository (100) also stores an overall feature importance matrix (132). The overall feature importance matrix (132) represents the importance of the features (114) used as input to the stacked ensemble model (102) to the determination of the final output (112). Thus, the contribution matrices (126) represent the influence of the various inputs to an associated component model (104), while the overall feature importance matrix (132) represents the influence of the features (114) to the stacked ensemble model (102) as a whole. The overall feature importance matrix (132) may be vector with each row corresponding to a different feature (114) used as input.

The data repository (100) also stores first feature importance scores (134) and second feature importance scores (136). The first feature importance scores (134) measure the importance of features (114) in the first subset (118) on the final output (112). The second feature importance scores (136) measure an importance of features (114) in the second subset (120) on the final output (112). The second feature importance scores (136) may be an aggregation of the importance of features (114) in the second subset (120), such as a sum of the importance of all the features (114) in the second subset (120), or a maximum value of the importance of all the features (114) in the second subset (120).

The data repository (100) also stores an explanation (138) indicating the factors which influence the final output (112). The explanation (138) may be a list of the top contributing factors to the final output (112). The explanation (138) may also include the measured importance for each of the top contributing factors. The explanation (138) may be further refined, such as a natural language message selected according to the top features that contributed to the model output.

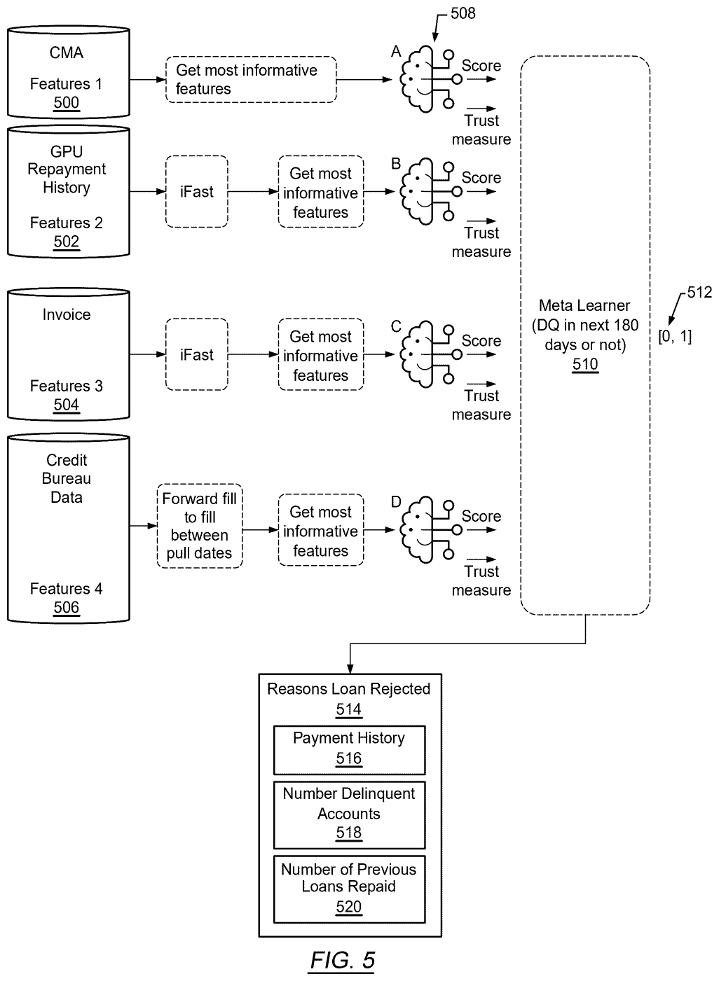

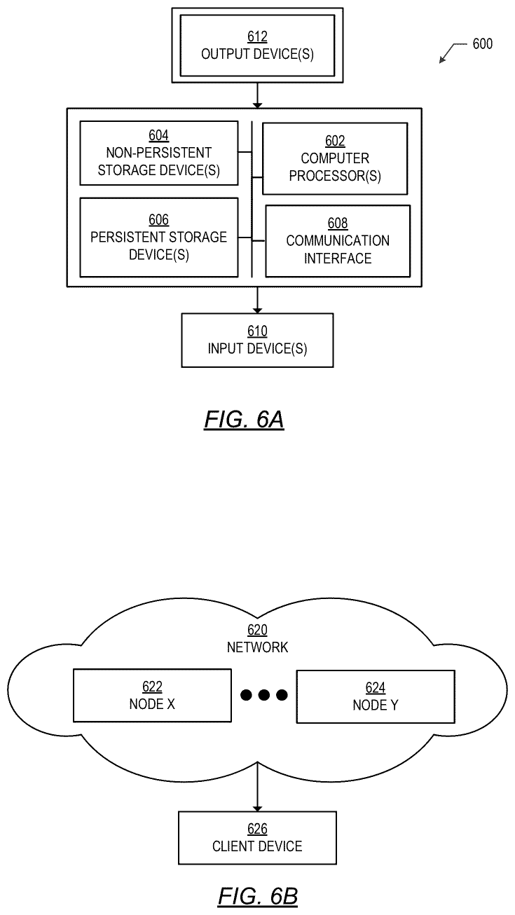

The system shown in FIG. 1 may include other components. For example, the system shown in FIG. 1 also may include a server (142). The server (142) is one or more computer processors, data repositories, communication devices, and supporting hardware and software. The server (142) may be in a distributed computing environment. The server (142) is configured to execute one or more applications, such as the server controller (146) and the matrix dot multiplier (148). An example of a computer system and network that may form the server (142) is described with respect to FIG. 6A and FIG. 6B.

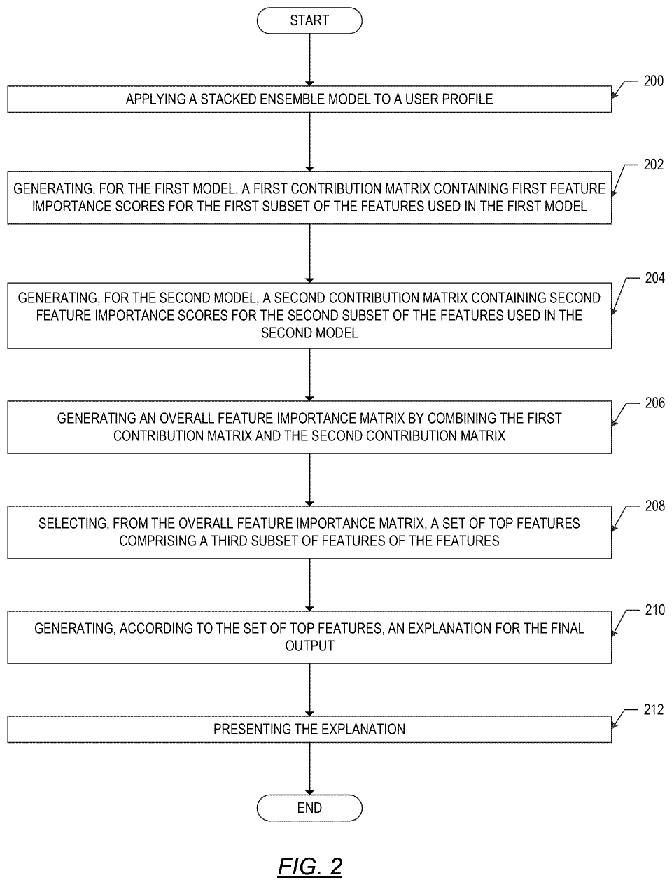

The server (142) includes a processor (144). The processor (144) is one or more hardware or virtual processors which may execute computer readable program code that defines one or more applications, such as server controller (146) and the matrix dot multiplier (148). The processor (144) may execute computer readable program code that may embody the method of FIG. 2. An example of the processor (144) is described with respect to the computer processor(s) (602) of FIG. 6A.

The server (142) also may include a server controller (146). The server controller (146) is software or hardware programmed to coordinate the software or hardware to accomplish one or more methods described herein. For example, the server controller (146) may be software or hardware programmed to execute one or more steps of the method of FIG. 2. The server controller (146) also may control or coordinate the functions of the matrix dot multiplier (148), described below.

The server (142) also may include a matrix dot multiplier (148). The matrix dot multiplier (148) is software or hardware programmed to process one or more matrices (e.g., first contribution matrix (128) and second contribution matrix (130)). The output from the matrix dot multiplier (148) may be another matrix of the features that results when a dot multiplication product of the contribution matrices is performed. An example of the output of the matrix dot multiplier (148) may be the overall feature importance matrix (132).

FIG. 1 also shows one or more user devices (150). The user devices (150) are the computing systems which users interact with the server (142). The user devices (150) may include a user input device (152), such as a mouse, keyboard, microphone, touch screen, haptic device, etc., with which the user may interact. The user devices (150) may also include a display device (154), such as a screen. Thus, the user devices (150) are computing systems which a user may use to interact with the server (142). For example, the explanation (138) may be received from the server (142) and presented on the display device (154), as described in step 212 of FIG. 2.

In many cases, the user devices (150) are not part of a system owned or operated by the entity that owns or operates the server (142). Such user devices (150) may be referred to as “remote” devices, and thus may not be part of the system of FIG. 1. However, one or more of the user devices (150) may be part of the same system of which the server (142) is a part. In this case, such user devices (150) may be referred to as “local” devices, even if the user devices (150) are not in the same physical geographical location. Local devices may be considered part of the system shown in FIG. 1.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for providing an explanation of an output of an ensemble model, in accordance with one or more embodiments. The method of FIG. 2 may be implemented using the system of FIG. 1 and one or more of the steps may be performed on or received at one or more computer processors.

Step 200 includes applying a stacked ensemble model to a user profile. Features and the associated values are extracted from the user profile. The features are used as input to the stacked ensemble model. Then, the ensemble model is executed in order to produce a final output. The final output may be a number representing a prediction. The number may be compared to a decision in order to determine whether to act (or not).

As one example, the stacked ensemble model may be used to determine whether a user should be authorized to access a document. The features may include various details regarding the user, such as the user's current location, recent log-in locations, devices used, etc. In another example, the stacked ensemble model may be used to determine whether a transaction may be fraudulent, based on the user's payment history, credit rating, etc.

Step 202 includes generating a first contribution matrix. The first contribution matrix is created by assigning, for the models in the first layer (which includes the first model), feature importance scores to various positions in the matrix. The feature importance scores of the first contribution matrix are determined by one or more explainer models that executes on the component models in the first layer and outputs of the component models. The models in the first layer receive as input features extracted from the user profile. In the first contribution matrix, the feature importance score for a feature represents the contribution of the extracted feature (which is used as an input to the model) to the output of the model at the first level.

The feature importance score may be a Shapley value. A Shapley value provides a numerical representation of the contribution of a feature to the output of a model (or contribution to the uncertainty of the output of the model). The Shapley value indicates how important the feature is to the determination of the final output.

The Shapley values may be generated using an explainer. The explainer is a type of machine learning model that takes as input a model (e.g., a component model from a stacked ensemble model) and sample datasets (e.g., sample values for the features). The explainer produces a list of the input features with associated Shapley values. The Shapley values for the features indicate the importance the feature received as input to the output produced by the model.

Step 204 includes generating, for the second model, a second contribution matrix. The second contribution matrix is created by assigning feature importance scores to various elements of the second contribution matrix for the models in a layer subsequent to the first layer. The feature importance scores of the second contribution matrix are determined by one or more explainer models that executes on the component models in the first layer and outputs of the component models. The models in the subsequent layer receive as input intermediary features generated as output by a model in a preceding layer. In the second contribution matrix, the feature importance score for an intermediary feature represents the contribution of the intermediary feature to the output of the model at the subsequent level. Additional intermediary layers, and thus additional contribution matrices storing additional features, may be present. On the final layer, the output is the final output.

The feature importance score in the second contribution matrix may be calculated based on the importance scores of the input features (such as determined for a preceding model). The calculated feature importance score may be a combination of the input feature importance scores, such as a summation, a multiplication, or some other operation combining the input feature importance scores. Alternatively, the calculated feature importance score may be a maximum of the input feature importance scores for each input feature.

Step 206 includes generating an overall feature importance matrix by combining the first contribution matrix and the second contribution matrix. The overall feature importance matrix may be created by dot-multiplication of the first contribution matrix and the second contribution matrix. Additional contribution matrices may be combined. For example, each layer of the stacked ensemble model may have an associated contribution matrix, and the combination may be the dot-multiplication of each contribution matrix.

The overall feature importance matrix may be a vector matrix having one column and a row for each input feature. Each row of the vector matrix indicates the significance of a corresponding input feature.

Step 208 includes selecting, from the overall feature importance matrix, a set of top features including a third subset of the features. The top features may be selected as the highest scored features in the overall feature importance matrix. The top features may be limited to a preselected number of features, for example, the top 10 features, top 20 features, etc.

Step 210 includes generating, according to the set of top features, an explanation for the final output. The explanation may be a list of the top features for the model's final output and may include an indication of an importance of the top features.

For example, each of the top features may be reported with an associated Shapley values for the top features. A Shapley value provides a numerical representation of the contribution of a feature to the final output (or contribution to the uncertainty of the final output). The Shapley value indicates how important the feature is to the determination of the final output.

In another example, the top features may be reported with an associated Owen value for each top feature. Owen values are extensions of Shapley value which take into consideration how various features work together.

The explanation includes an identification of the top features from the features extracted from the user profile. The explanation may also include a relative score (or weight) of each top feature to the final output. The top features may be sorted by highest-scored to lowest-scored.

Step 212 includes presenting the explanation. Presenting may include displaying the explanation on a user device. However, presenting may also include providing the explanation to another program for further processing. Presenting also may include storing the explanation in a non-transitory computer readable storage medium. Presenting also may include transmitting the explanation to another device, such as a user device.

While the various steps in this flowchart are presented and described sequentially, at least some of the steps may be executed in different orders, may be combined or omitted, and at least some of the steps may be executed in parallel. Furthermore, the steps may be performed actively or passively.

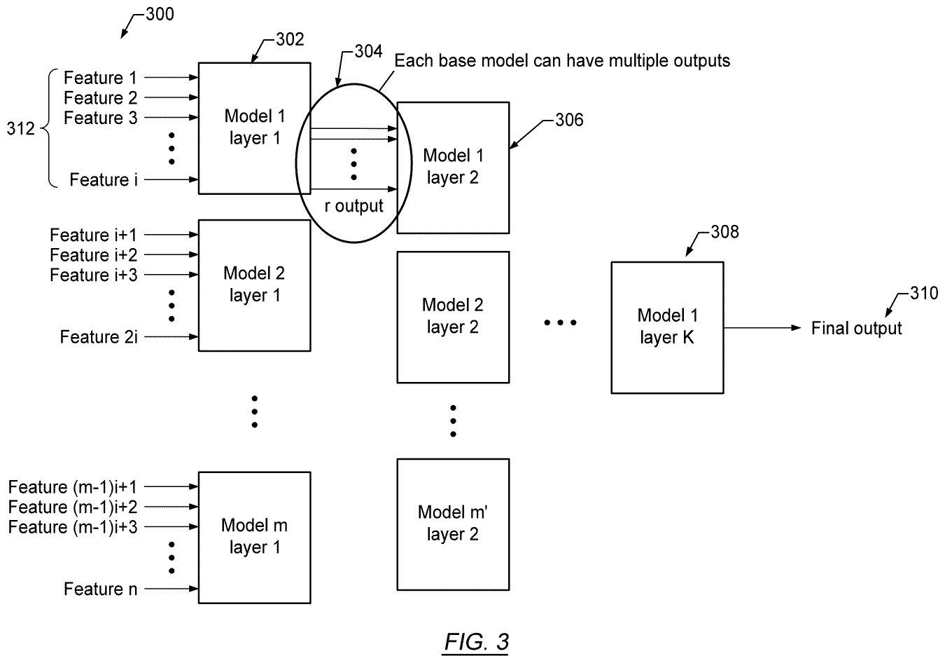

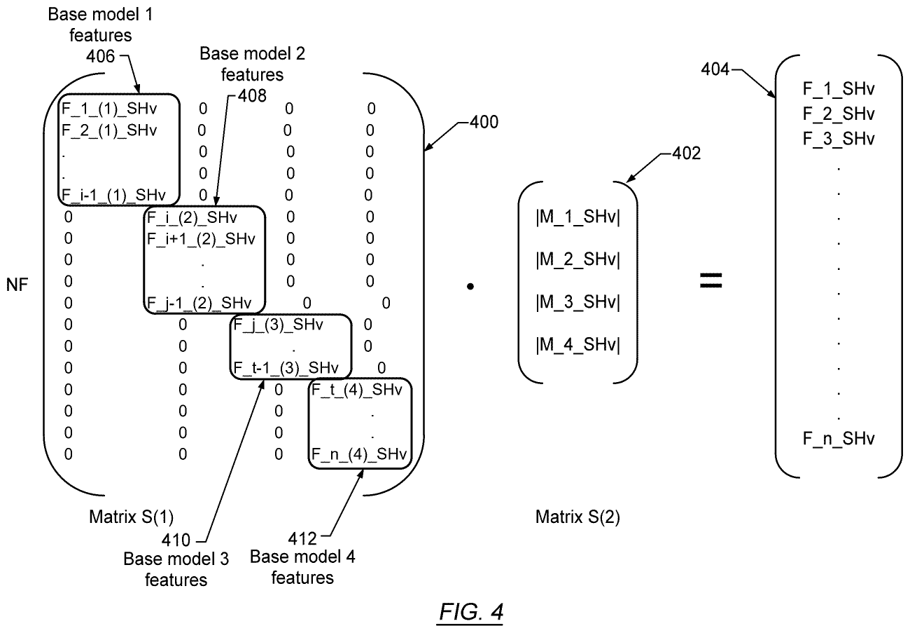

FIG. 3 and FIG. 4 show examples of the generation of an explanation of ensemble model output, in accordance with one or more embodiments. Attention is first turned to FIG. 3, which shows an example of a stacked ensemble model, such as the stacked ensemble model (102) shown in FIG. 1.

The ensemble model in FIG. 3, includes multiple models distributed over various layers. As shown, first layer models (302) are on the first layer, second layer models (306) are on the second layer and a final layer model (308) is on the final layer, layer K.

Features (300) are used as inputs to the first layer models (302). Features (300) may be grouped into subsets based on the first layer models (302) that receive the features as inputs. For example, first subset (312) includes the features (300) that are applied to a first model of the first layer models (302).

Each first layer model (302) may produce one or more outputs (304) such as shown for Model 1. The outputs (304) from the first layer models (302) are used as input features for the second layer models (306). The outputs of the second layer models (306) may then be used as input features for a succeeding layer. This process is repeated until the final layer model (308) reached.

The final layer model (308) receives the output of the models from the preceding layer (layer K-1, not shown) and produces final output (310). The final output (310) may be a numerical value or a Boolean value, for example representing a prediction. The prediction may be used to determine whether or not to act (e.g., approve a loan application, etc.).

The contribution of a feature at the first level model may be calculated. Then, the contribution of the output of the first level model is calculated for the second level model, and so on. To formulate the contribution of the features, a matrix A(k) of size n by m is used in the stack model at layer k. The value of n identifies the number of features (inputs). The value of m identifies the number of base models at layer k, is constructed.

For each model at level k, the feature importance for the base model M (m, k) where k identifies the layer and m is the model number at that level is determined. The matrix A(k) (which is the matrix containing the feature importance scores for all models at level k), at positions [i:j, m] which denotes column m and rows i to j, is filled in with the corresponding feature importances. Each model's output feature is represented in a separate column.

Rows i to j are selected such that (j−i)+1 is the number of inputs to model m. The value i denotes number of features filled in by models 1 to (m−1). The Eq. 1 may be used to create the overall feature importance matrix:

$$F = A ( 1 ) * A ( 2 ) * A ( k ) * ... * A ( K ) \qquad ( 1 )$$

A(1) is size n×m, A(2) is mx1, . . . and A(K) is a vector (where K is the last level). The vector F is the dot product of all the matrices constructed. F has nx1 dimensions, where each row in F identifies the importance of the feature. The transpose of F is given in Equation 2:

$${F}^{T} = {[ imp\_feat \_ 1 , imp\_feat \_ 2 , imp\_feat \_ 3 , … , imp\_feat \_n ]}^{T} \qquad ( 2 )$$

One way to provide an explanation for the model's final output is to use Shapley values. The Shapley values may be determined using a classifier, such as a SHAP explainer, for each base model at level 1.

Attention is turned to FIG. 4. The matrix equation in FIG. 4 represents component matrices using Shapley values for a single output base learner. Matrix S(1) (400) represents four first level models (or Base models) and matrix S(2) (402) represents a single level 2 model. As shown, matrix S(2) (402) is m by 1 matrix. In this example, m is the number of models at level 1, and here the value of m is 4. The dot-product of the matrix S(1) (400) and matrix S(2) (402) is the Matrix (404). The Matrix (404) is the overall feature importance matrix indicating the contribution of each feature to the final output.

The Shapley values are used to construct the matrix S(1) (400). The Shapley value for each input features of each model is provided in an associated row of the matrix S(1) (400). Sub-section (406) shows the Shapley values for the inputs to the first model. Likewise, sub-section (408) shows the Shapley values for the inputs to the second model, sub-section (410) shows the Shapley values for the inputs to the third model, and sub-section (412) shows the Shapley values for the inputs to the fourth model.

In FIG. 4, F_i_ (m)_SHv is the Shapley value for feature i from first layer model m. M_m_SHv is the Shapley value for the input feature i to the second layer model from the first layer model m. F_i_SHv is the Shapley value for the feature i on the final output.

A normalizing factor, NF, may be used as well. The normalizing factor is calculated by summing the absolute value of the Shapley values of the input features to the second layer model. Each first layer base model target definition is the same as the final (or meta) model. Thus, using the absolute value of the Shapley values allows the direction of each Shapley value (relative to the feature) to be extracted from the first layer base model. The normalizing factor may be determined by Eq. 3:

$$NF = \frac{1}{{\sum }_{m = 1}^{M} \vert M\_m \_SHv \vert} \qquad ( 3 )$$

When the outputs from first layer base models are used as inputs to the subsequent layer, additional features may be added. The additional features can include existing model scores, or features being left out from the base layer. In this scenario, the feature independence of Shapley values may not be met anymore.

To handle such situations, a feature grouping for the subsequent model is created. This can be done through masking all the inputs to the subsequent model. For example, there are three base models and three groups of features created for the subsequent layer corresponding to the three base models, namely A:=(x11, x12, . . . , x1n), B:=(x21, x22, x2n), and C:=(x31, x32, . . . , x3n).

Owen values (OV) may be calculated for each group. The OV is an extension of Shapley value that allows features in the same group to act as one feature coalition. For the meta model, the sum of OV for each group is determined. For example, for the three base models A, B, and C, the OV are: OVA, OVB, OVc. OV weights are then determined for each group: w1=|OVA|/(|OVA|+|OVB|+|OVc|), w2=|OVB|/(|OVA|+|OVB|+|OVc|), and w3=|OVc|/(|OVA|+|OVB|+|OVc|). The weights may then be applied to the Shapley values for each base model.

FIG. 5 shows an example of the generation of an explanation of an ensemble model output, in accordance with one or more embodiments. The following example is for explanatory purposes only and not intended to limit the scope of one or more embodiments.

As shown in FIG. 5, the ensemble model includes 4 first layer models (508)—A, B, C and D. The input features to the ensemble model are derived from various sources. A user profile may be used to check the various sources for features to be applied to the first layer models (508).

The first subset of input features, Features 1 (500), come from a first data sourceand are applied to model A. Likewise, the second subset of input features, Features 2 (502), come from a second data source and are applied to model B, the third subset of input features, Features 3 (504), come from a third data source and are applied to model C, and the fourth subset of input features, Features 4 (506), come from a fourth data source and are applied to model D. The features may be pre-processed to identify the features that are deemed more informative, for example, derived from more recent data, etc.

The first layer models (508) are applied to the respective Features (500, 502, 504, and 506) and provide as output a score and trust measure. The output is applied to the meta learner (510) to determine if the user is expected to be delinquent in the next 180 days or not. The final result (512), a 0 or 1 based on the determination, is provided as the final output.

As shown in FIG. 5, the meta learner (510) also provides an explanation, potential fraud was detected (514), for the final result (512). In this example, the reasons the system detects a potential fraud case (514) include information based on payment history (516), number of delinquent accounts (518), and number of previous loans repaid (520). The reasons correspond to top features that were determined to be the highest contributions to the prediction generated by the ensemble model. The reasons fraud was detected (514) allow a review of the determination and confirmation of the ensemble model's results.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 6A, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many different types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (602), is configured to perform one or more embodiments, which may include transmitting, receiving, presenting, and displaying data and messages described in the other figures of the disclosure.

The computing system (600) in FIG. 6A may be connected to, or be a part of, a network. For example, as shown in FIG. 6B, the network (620) may include multiple nodes (e.g., node X (622) and node Y (624), as well as extant intervening nodes between node X (622) and node Y (624)). Each node may correspond to a computing system, such as the computing system shown in FIG. 6A, or a group of nodes combined may correspond to the computing system shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6A. Further, the client device (626) may include or perform all or a portion of one or more embodiments.

The computing system of FIG. 6A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
applying a stacked ensemble model to a user profile, the stacked ensemble model comprising a plurality of component models, wherein:
the stacked ensemble model operates on a plurality of features to generate a final output, and wherein values for the plurality of features are extracted from the user profile,
the stacked ensemble model comprises a first model at a first layer and a second model subsequent to the first model,
the first model operates on a first subset of the plurality of features to generate an intermediary feature, and
the second model receives, as input, the intermediary feature and also operates on a second subset of the plurality of features to generate the final output;
generating, for the first model, a first contribution matrix containing first feature importance scores for the first subset of the plurality of features used in the first model;
generating, for the second model, a second contribution matrix containing second feature importance scores for the second subset of the plurality of features used in the second model;
generating an overall feature importance matrix by combining the first contribution matrix and the second contribution matrix;
selecting, from the overall feature importance matrix, a set of top features comprising a third subset of the plurality of features;
generating, according to the set of top features, an explanation for the final output; and
presenting the explanation.

2. The method of claim 1, wherein the stacked ensemble model is a tree-based model.

3. The method of claim 1, wherein the overall feature importance matrix is a vector matrix where each row indicates a significance of a corresponding input feature.

4. The method of claim 1, wherein the second feature importance scores comprise summations of an input feature importance score for each input feature to the second model.

5. The method of claim 1, wherein the second feature importance scores comprise a maximum value of input feature importance scores for each input feature to the second model.

6. The method of claim 1, wherein the stacked ensemble model comprises layers of a single machine learning model.

7. The method of claim 1, wherein the stacked ensemble model comprises a plurality of different machine learning models.

8. The method of claim 1, wherein the stacked ensemble model comprises a combination of layers of a single machine learning model and a plurality of different machine learning models.

9. The method of claim 1, wherein the first subset of features is different from the second subset of features.

10. The method of claim 1, wherein:
the first contribution matrix comprises a first column representing the first model, and
each input to the first model corresponds to a row of the first contribution matrix corresponds to an input to the first model.

11. The method of claim 1, wherein generating the explanation for the final output comprises generating Shapley values.

12. The method of claim 1, wherein the first contribution matrix comprises a first column representing a first output of the first model and a second column representing a second output of the first model.

13. The method of claim 1, wherein generating the first contribution matrix and the second contribution matrix comprises:
calculating an associated Owen value for each component model at the first layer;
calculating an Owen value sum based on the associated Owen value for the each component model at the first layer; and
for the first model, determining an associated weight for the first contribution matrix based on the Owen value sum,
wherein generating the first contribution matrix is based, in part, on the associated weight for the first model.

14. A system comprising:
a server comprising a processor;
a stacked ensemble model executable by the processor and comprising a plurality of component models, the plurality of component models comprising a first model at a first layer and a second model subsequent to the first model;
a data repository in communication with the processor, and storing:
a user profile comprising a plurality of features, and
a first subset of the plurality of features used in the first model;
a second subset of the plurality of features used in the second model;
a first contribution matrix containing first feature importance scores for the first subset;
a second contribution matrix containing second feature importance scores for the second subset of the plurality of features used in the second model;
an overall feature importance matrix;
a set of top features comprising a third subset of the plurality of features; and
an explanation for a final output of the stacked ensemble model;
a matrix combiner, wherein the processor is programmed to apply the matrix combiner to the first contribution matrix and to the second contribution matrix to output the overall feature importance matrix; and
a server controller executable by the processor to perform a computer-implemented method comprising:
applying the stacked ensemble model to the user profile; and
generating, for the first model, the first contribution matrix;
generating, for the second model, the second contribution matrix;
generating the overall feature importance matrix by combining the first contribution matrix and the second contribution matrix;
selecting, from the overall feature importance matrix, the set of top features;
generating, according to the set of top features, the explanation; and
presenting the explanation.

15. The system of claim 14, wherein the overall feature importance matrix is a vector matrix where each row indicates a significance of a corresponding input feature.

16. The system of claim 14, wherein generating second contribution matrix comprises summing an input feature importance score for each input feature to the second model.

17. The system of claim 14, wherein generating second contribution matrix comprises determining a maximum value of input feature importance scores for each input feature to the second model.

18. The system of claim 14, wherein:
a first column of the first contribution matrix represents the first model; and
each input to the first model corresponds to a row of the contribution matrix.

19. The system of claim 14, wherein the first contribution matrix comprises a first column representing a first output of the first model and a second column representing a second output of the first model.

20. A method comprising:
applying a stacked ensemble model to a user profile, the stacked ensemble model comprising a plurality of component models, wherein:
the stacked ensemble model operates on a plurality of profile features to generate a final output, and wherein values for the plurality of profile features are extracted from the user profile,
the stacked ensemble model comprises a first model at a first layer and a second model subsequent to the first model,
the first model operates on a first subset of the plurality of profile features to generate a first intermediary feature, and
the second model generates the final output, based at least in part on the first intermediary feature;
generating, for the first model, a first contribution matrix containing first feature importance scores for the first subset of the plurality of profile features used as input to the first model, wherein:
a first column of the first contribution matrix represents the first model; and
each input to the first model corresponds to a row of the first contribution matrix;
generating, for the second model, a second contribution matrix aggregating second feature importance scores for input features used as input to the second model;
generating an overall feature importance matrix by combining the first contribution matrix and the second contribution matrix, the overall feature importance matrix is a vector matrix where each row indicates a significance of a corresponding input feature;
selecting, from the overall feature importance matrix, a set of top features comprising a second subset of the plurality of profile features;
generating, according to the set of top features, an explanation for the final output, the explanation comprising a weighted value representing an importance of the top feature in determining the final output; and
presenting the explanation.
